(19) United States
(12) Patent Application Publication
(10) Pub. No.: US 2016/0082936 A1
(43) Pub. Date: Mar. 24, 2016

(54) Method for Braking a Motor Vehicle

(71) Applicant: Bayerische Motoren Werke Aktiengesellschaft, Muenchen (DE)

(72) Inventors: Peter LANGEN, Woerthsee (DE); Georg EICHNER, Ismaning (DE); Georg KOHL, Unterschleissheim (DE); Siegfried KOELBEL, Pfaffenhofen (DE)

(21) Appl. No.: 14/956,540

(22) Filed: Dec. 2, 2015

Related U.S. Application Data
(63) Continuation of application No. PCT/EP2014/059990, filed on May 15, 2014.

(30) Foreign Application Priority Data
Jun. 21, 2013 (DE) 10 2013 211 856.2

(51) Int. Cl. B60T 8/1766

(52) U.S. Cl. CPC B60T 8/1766

(57) ABSTRACT

A method is provided for braking a motor vehicle equipped with wheel brakes without a hydraulic connection to a brake-operating device, and with a service brake unit having a brake actuator, which, triggered by an output signal of the brake-operating device and ultimately with the aid of a control device, loads the wheel brakes in a wheel- or axle selective manner so that the braking force changes at least on one wheel or at least on one axle. The method is characterized in that a total setpoint braking force that decelerates the motor vehicle is distributed via the brake actuator to the individual wheels or axles by the control device.

### CROSS REFERENCE TO RELATED APPLICATIONS

This application is a continuation of PCT International Application No. PCT/EP2014/059990, filed May 15, 2014, which claims priority under 35 U.S.C. §119 from German Patent Application No. 10 2013 211 856.2, filed Jun. 21, 2013, the entire disclosures of which are herein expressly incorporated by reference.

### BACKGROUND AND SUMMARY OF THE INVENTION

The invention relates to a method for braking a motor vehicle having wheel brakes without a hydraulic pressure connection to a brake actuating unit and having a service brake unit having a brake actuator.

The occurrence of so-called brake squeal in disc brakes is based on the so-called stick-slip effect, which refers to the stick-slip of solid bodies moved against one another. The effect can occur when the static friction is greater than the sliding friction. In this case, damped coupled surface parts execute a rapid movement sequence of sticking, tensioning, separation, and balancing, which, depending on the tribological system, excites oscillations which are emitted from a resonance-capable surface as noise. Brake squeal typically occurs in specific brake pressure ranges, i.e., not over the entire applicable brake pressure range. The brake pressure is dependent, inter alia, on the brake pressure distribution on the front and rear.

DE 198 04 676 A1 describes a method for avoiding squeal noises on brake discs, wherein a remedy is provided using a pressure control unit for applying pressure to the wheel brakes or for adapting the brake pads thereof. The squeal of the brake discs is to be detected metrologically and eliminated by modulation of the contact pressure of the brake pads to one or more wheel brakes. The metrological detection can be performed by oscillation pickups, microphones, or by pressure transducers.

WO 2011/069716 A1 describes a braking method, in which, on the one hand, there is no longer a mechanical coupling between brake pedal and brake actuator and, on the other hand, brake squeal is also prevented at the same time. The brake force acting on the brake is to be automatically varied, above all in a phase in which an essentially constant brake pressure is requested by the driver or a brake assistance system, to thus prevent the squeal. In this case, the modulation of the brake force is to be performed by a control unit, which activates an electric motor, for example. The dynamic response or amplitude of the automatic brake force modulation can be specifically fixed depending on the braking situation. The mentioned modulation of the brake force can be triggered by a predefined trigger signal, for example, a specific noise or a mechanical oscillation. For example, an acoustic sensor can be provided for measuring the squeal noise.

DE 103 12 545 B4 describes a method for operating a brake system, in which a brake pressure value is ascertained and checked for association with a reference range and, in dependence on the result of this check, measures for regulating the brake pressure are activated so that the ascertained brake pressure value is distributed to at least one front wheel brake/rear wheel brake while avoiding the reference range.

DE 102 005 056 986 A1 also describes a method for preventing brake squeal. In this case, the total braking torque, at least in a specific range of brake pressures in which brake squeal occurs, is distributed to the wheels of the front axle and rear axle via a brake force regulating unit.

The object of the invention is to provide a method for braking a motor vehicle having wheel brakes designed as friction brakes without a hydraulic pressure connection to a brake actuating unit, using further functions which can be fulfilled cost-effectively and which are triggered by an event.

This and other objects are achieved according to the invention by a method for braking a motor vehicle having wheel brakes without a hydraulic pressure connection to a brake operating unit. The motor vehicle has a service brake unit having a brake actuator, which, triggered by an output signal of the brake operating unit, and ultimately with the aid of a control unit as a result of at least one event, applies pressure to the wheel brakes in a wheel-selective or axle-selective manner. The pressure is applied such that the brake force varies at least at one wheel or at least at one axle, wherein the method is characterized in that a total setpoint brake force which decelerates the motor vehicle is distributed by the control unit via the brake actuator to the individual wheels or axles.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a simplified flowchart illustrating an exemplary method according to the present invention.

### DETAILED DESCRIPTION OF THE DRAWING

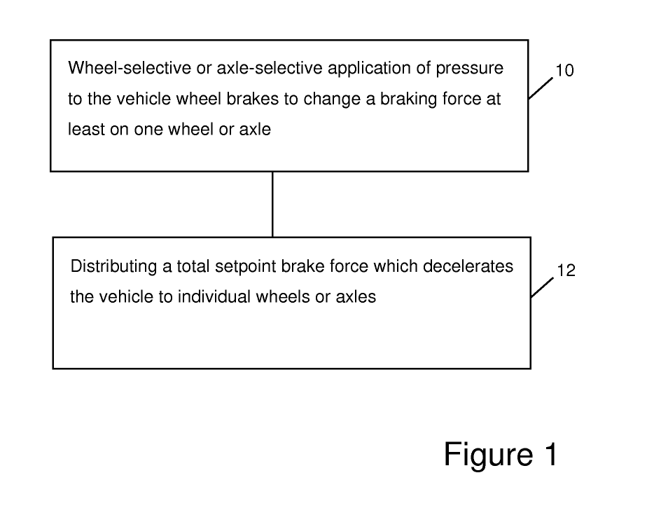

Referring to the flowchart of FIG. 1, a method for braking a motor vehicle equipped with wheel brakes that do not have a hydraulic pressure connection to a brake operating device, and equipped with a service brake unit having a brake actuator, is provided. The method includes the acts of applying pressure to the wheel brakes in a wheel-selective or axle-selective manner to change the braking force at least on one wheel or one axle, via the brake actuator triggered by an output signal of the brake operating unit caused by a defined event and with the aid of a control unit (10). With the method, a total setpoint brake force which decelerates the motor vehicle is distributed via the brake actuator to individual wheels or axles by the control unit (12)

In this method for braking a motor vehicle, the total setpoint brake force predefined by the control unit can advantageously be allocated thereby or by the brake actuator, as a result of the event, differently to the individual wheels or axles. This allocation also includes, of course, a wheel-selective or axle-selective change of the frequency and/or the mean value and the associated amplitudes of the brake force during the application of intermittent braking to one or more wheels by the brake actuator, as is already known according to the prior art. When such intermittent braking is applied and varied, this is haptically detectable or also acoustically perceptible to the vehicle occupants or the driver, which often significantly impairs the driving comfort.

Therefore, a preferred embodiment of the invention provides activating the brake actuator by way of the control unit in such a manner that, in a wheel-selective or axle-selective manner, different brake force modulations having different frequencies and/or brake force mean values and/or amplitudes are applied to the wheel brakes, but this is done in such a manner that the total setpoint brake force decelerating the vehicle is distributed by the control unit via the brake actuator onto the individual wheels or axles so that a deceleration, which acts on the vehicle and originates from the total setpoint brake force, having the brake forces varying in a wheel-selective or axle-selective manner, is haptically perceived as continuous and is acoustically not perceptible to the driver and further occupants of the motor vehicle. This also relates to the brake squeal, which is suppressed by brake force modulation and/or frequency variation, by use of the methods already disclosed in the prior art, by the wheel-selective or axle-selective activation of the brake actuator via the control unit, and is therefore not acoustically perceptible.

Such an integration of the regulating adjustment against brake squeal in wheel brakes without hydraulic pressure connection into a brake operating unit results in only minor additional costs, whereby squeal noises are suppressed in a cost-effective and easily controllable manner.

Further preferred embodiments of the invention provide that, via at least one sensor, which is in particular already provided in the motor vehicle (for example, the microphone already provided in the motor vehicle interior), a brake squeal noise is already recognized at the beginning of its occurrence and is prevented by the above-described measures, for example, by wheel-selective or axle-selective brake pressure control via the brake actuator activated by the control unit. Therefore, upon recognizing a brake squeal noise via a specific sensor system on a vehicle axle, front or rear, a partial brake force can be displaced by the control unit and brake actuator to the other vehicle axle and therefore the squeal noise can be suppressed by reducing the brake pressure on the squealing wheel. This can be controlled within such narrow limits that no squealing at all is perceptible to the vehicle occupants. Such measures for avoiding brake squeal can also be applied in the regulated brake actuating range, of course, even if no brake pedal is actuated.

In one advantageous embodiment of the invention, the control unit is designed as self-learning and can therefore permanently suppress brake squeal, after it has been recognized once by use of the sensor. The control unit automatically recognizes and stores the boundary conditions which are relevant for the brake squeal, for example, external temperature, ambient humidity, speed, travel direction, brake disc temperatures, steering angle, and dampness. Values which can be calculated can also be calculated by the control unit or other computing devices, for example, the brake disc temperatures via a brake disc temperature computing program. When squealing occurs, this is recognized via the sensor and the values of the boundary conditions are stored. To eliminate the brake squeal when these boundary conditions exist again, the brake pressure is then modulated on the four wheels depending on the driving situation, by the control unit and the brake actuator while maintaining the driver command brake torque.

Additionally or alternatively, boundary conditions of situations in which brakes are known to squeal can be stored via a program map. A further possibility for squeal recognition is offered by the wheel speed sensor system of the ABS sensor or an acceleration pickup on the steering knuckle or wheel instead of a microphone. If a critical range for the brake squeal is reached, the relevant brake pressure range, if still comfortably possible, can be blanked out automatically, i.e., lower or higher brake pressures are modulated by the control unit. A compensation is optionally performed via the application of pressure to the individual brakes, so that the deceleration desired by the driver again occurs. Noises in the application range of the brake pads can be reduced, in that this pressure range is passed through rapidly or avoided entirely. For example, only brake pressures greater than 3 bar can be output by the control unit. To achieve harmonic response behavior, it is also possible to first only brake one of the two axles and then to brake the second axle later in the event of a further desired brake pressure increase. Braking subject to noise can then be avoided entirely.

In a further advantageous method according to the invention, an onboard analysis is performed as to whether brakes are squealing on the front or rear. If brake squeal occurs, the control unit successively varies the pressure for each brake upward or downward via the brake actuator, until the squeal noise changes or stops. Because of the relationship that only the pressure-impinged brake can squeal, it is therefore easy to locate the squealing wheel brake. This information can additionally be input into a fault memory and then can be read out again by the service department for a targeted repair and can be used by the control unit for further squeal avoidance measures.

Further advantageous methods according to the invention can be characterized by the following features.

For example, it is recognized by the control unit that the vehicle has been subjected for a long time to specific adverse weather conditions and shutdown times. After long shutdown times, in particular in damp conditions, appearances of rust bloom occur on the brake disc surfaces, which significantly increase the tendency toward braking noise. The control unit then initiates automatic polarization braking in driving operation, for example, also only on individual wheel brakes, which are not perceived by the occupants, since this relates to braking at very light brake pressure.

For example, braking noises and the corresponding boundary conditions are sensed via microphone and subsequently recorded in the control unit. The data can then be made accessible for the service department, i.e., a workshop can read out, for example, the frequency and volume of the brake squeal from a fault memory at the service department in a qualified manner.

To avoid worsened response behavior of the wheel brakes in damp conditions, controlled via the control unit, dry braking is carried out. The wheel brakes are successively activated individually or by axle. The dry braking is thus not perceptible to an occupant even at higher pressure level, because of the reduced number of wheel brakes which are sequentially activated.

For example, oscillations or noises on the motor vehicle can be suppressed by brake intervention via the control unit and brake actuator, for example, on one side or on one wheel brake. This can relate to drivetrain, engine, transmission, chassis, and/or vehicle body both alone and also together.

Furthermore, traffic signal squeaking can be avoided. This breakaway noise of the brake pads can be generated by the driver in a playful manner via the brake pressure. If this is the case, the control unit can blank out the breakaway range, i.e., for example, feed brake pressures successively individually by wheel, to avoid rolling loose. The ability to meter the deceleration, i.e., the state between rolling and standing, is maintained in this case.

In addition, the brake force distribution from front to rear can be flexibly adapted to the driving situation and the brake load. A controlled change of the brake force distribution for driving-dynamics or load-related reasons would then be simple to simulate via the control unit and the brake actuator.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for braking a motor vehicle equipped with wheel brakes that do not have a hydraulic pressure connection to a brake operating device and equipped with a service brake unit having a brake actuator, the method comprising the acts of:
applying pressure to the wheel brakes in a wheel-selective or axle-selective manner to change the braking force at least on one wheel or one axle, via the brake actuator, triggered by an output signal of the brake operating unit caused by a defined event and with aid of a control unit, wherein
a total setpoint brake force which decelerates the motor vehicle is distributed via the brake actuator to individual wheels or axles by the control unit.

2. The method according to claim 1, wherein the total setpoint brake force that is distributed by the control unit via the brake actuator onto the individual wheels or axles is haptically perceptible as being continuous and is acoustically not perceptible to occupants of the motor vehicle.

3. The method according to claim 1, wherein the control unit applies pressure via the brake actuator to at least one wheel brake with intermittent braking, during which the brake force is applied in a varied or modulated manner with respect to frequency, amplitude and/or mean value.

4. The method according to claim 2, wherein the control unit applies pressure via the brake actuator to at least one wheel brake with intermittent braking, during which the brake force is applied in a varied or modulated manner with respect to frequency, amplitude and/or mean value.

5. The method according to claim 1, further comprising the act of:
determining the defined event for the wheel-selected or axle-selected braking pressure application via at least one sensor, output signals of the at least one sensor being transmitted to the control unit.

6. The method according to claim 5, wherein the at least one sensor determines a brake squeal noise and/or other brake noises.

7. The method according to claim 5, wherein the sensor determines an occurrence of moisture.

8. The method according to claim 6, wherein the sensor determines an occurrence of moisture.

9. The method according to claim 1, wherein a value of a required total setpoint braking deceleration is determined by the control unit based on signals of the brake operating unit, and/or signals of a distance regulating system or a traveling velocity regulating system.
